(19) United States
(12) Patent Application Publication
(10) Pub. No.: US 2005/0003119 A1
(43) Pub. Date: Jan. 6, 2005

(54) Self-adhesive covering for gluing over edges

(75) Inventor: Volker Hufnagel, Germering (DE)

Correspondence Address: NIXON PEABODY, LLP, 401 9TH STREET, NW, SUITE 900, WASHINGTON, DC, 20004-2128, US

(73) Assignee: Schreiner Group GmbH & Co. KG, Oberschleissheim (DE)

(21) Appl. No.: 10/792,380

(22) Filed: Mar. 4, 2004

(30) Foreign Application Priority Data
Mar. 7, 2003 (DE) 203 03 685.9

(51) Int. Cl. F16L 1/00

(52) U.S. Cl. 428/34.1; 428/343; 428/212

(57) ABSTRACT

A self-adhesive thin-layer covering including self adhesive regions having at least two adhesives having different adhesive properties, for gluing over an edge of a housing. At least one of the adhesives has a high initial adhesion which compensates for the shear and traction forces upon gluing over the edge and at least one of the adhesives develops a permanent and temperature-stable adhesive effect.

### TECHNICAL FIELD OF THE INVENTION

The present invention relates to a self-adhesive covering which is glued over edges. It is provided as a covering for an airbag housing in particular.

### BACKGROUND OF THE INVENTION

Airbags are installed in vehicles together with a housing. This is typically a plastic or metal housing into which the folded airbag is inserted and which is then provided with a (typically thin layer, i.e., film-like) covering. Coverings of this type must have the following properties:
They must tear apart at predetermined intended tear points when the airbag is triggered.
In addition, they must have a high stability in order to ensure that the enclosed airbag is stored securely.
They must also be attached stably to the housing.
They must retain these properties for a long time.

Self-adhesive achievements of this object are applied more and more in the field of coverings. Through a suitable material selection, sufficient stability of the covering itself may be achieved.

In contrast, the permanent application of the covering to the housing represents a basic problem: for example, an airbag covering which is equipped in the adhesive region with an adhesive with long-term and temperature stability and low initial adhesion does not adhere at a temperature below −35° C. Vice versa, an adhesive with high initial adhesion becomes stringy and detaches from the housing after two hours of high temperature storage at 80° C. because of the restoring forces of the material of the covering.

The problem therefore exists of producing an adhesive which both allows a high initial adhesion and allows the covering to remain permanently on the housing. Furthermore, it is to be ensured that the temperature spectrum of the adhesive bond is very broad. In this case, the restoring forces of the covering material which is glued over the edges of the housing represent a special problem. Adhesives having a requirement profile this broad are not known in the related art.

### SUMMARY OF THE INVENTION

It is the object of the present invention to ensure the stable application of the airbag covering to the housing. This is achieved by combining at least two different adhesives which advantageously supplement one another in their properties in such a way that the overall requirement spectrum for solid, permanent, and fast-acting gluing over an edge is covered.

A first adhesive having good initial adhesion ensures the fixing of the airbag covering on the housing from the instant of application. It absorbs mechanical traction and shear loads which would otherwise act on adhesive points which are provided with a second adhesive, having lower initial adhesion, with long-term and temperature stability. This second adhesive may therefore develop its adhesive force without mechanical load due to the forces occurring on the edge.

### BRIEF DESCRIPTION OF THE DRAWINGS

FIGS. 1a and 1b illustrate a covering in accordance with the present invention; and

FIGS. 2a and 2b illustrate the covering of FIGS. 1a and 1b positioned on a housing.

### DETAILED DESCRIPTION OF THE INVENTION

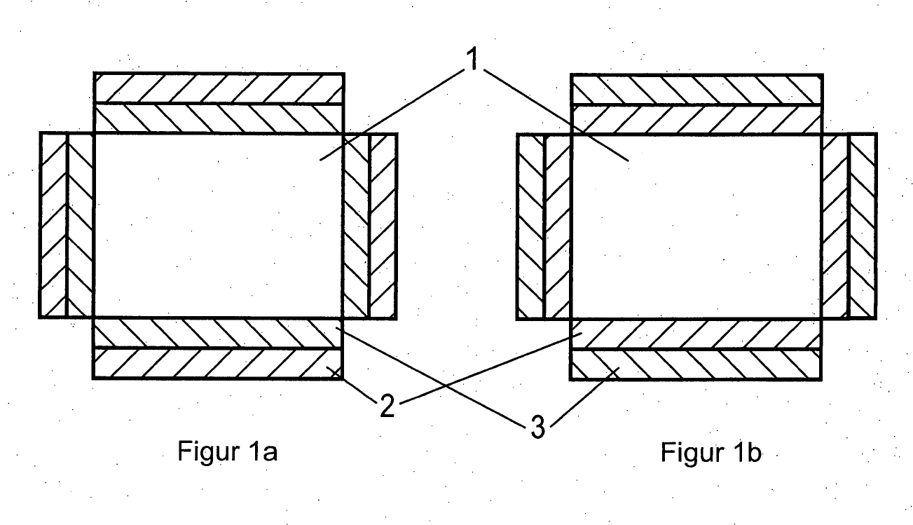

Different exemplary embodiments of the present invention are described in greater detail in FIGS. 1a and 1b. FIG. 1a represents an embodiment according to the present invention of a covering, especially an airbag covering 1, in which an adhesive 2 having high initial adhesion, but lower temperature resistance, is applied in the outermost zone on the edge for gluing to the housing. Further towards the middle of the covering, an adhesive coating 3 having lower initial adhesion and very good temperature resistance is located. As an alternative to this, the positioning of adhesive coatings 2 and 3 may be switched, as illustrated in FIG. 1b. If necessary, the properties of the combination of the two adhesives may thus be adapted to the external circumstances (for example, width and length of the strip provided with adhesive or the angle of the edges).

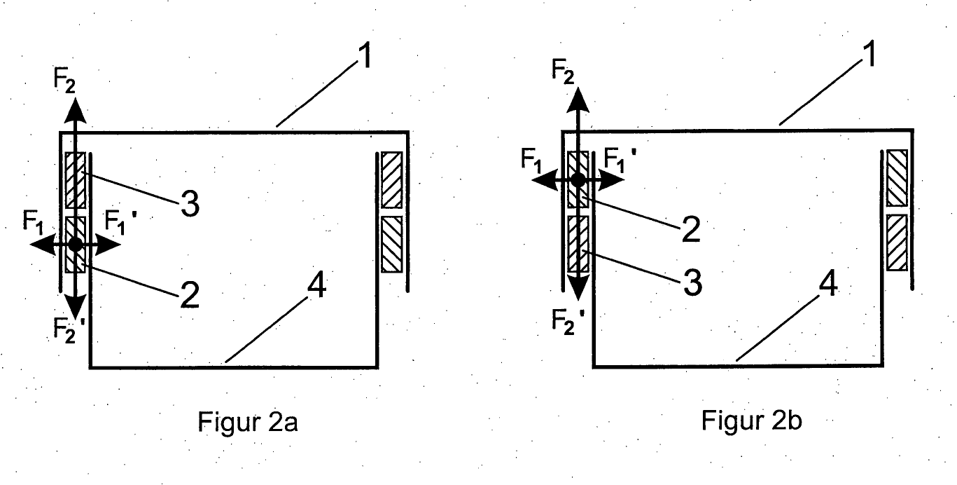

FIGS. 2a and 2b show the coverings according to the present invention from FIGS. 1a and 1b glued over the edge on a housing 4. In this case, the forces F₁ and F₂ (shear and traction forces) are applied, which are neutralized by the adhesive 2 upon application of the covering to the housing (counter forces F₁′ and F₂′).

A covering according to the present invention of this type may be used anywhere shear and traction forces arise when a film-like cover material is glued over an edge and both a permanent, temperature-stable gluing is necessary and a fast-acting adhesive effect upon application is required because of the effect of forces.

1. A self-adhesive thin-layer covering whose self-adhesive regions comprise at least two adhesives having different adhesive properties, for gluing over an edge,
wherein at least one of the adhesives has a high initial adhesion which compensates for the shear and traction forces upon gluing over the edge and at least one of the adhesives develops a permanent and temperature-stable adhesive effect.

2. The covering as recited in claim 1, wherein it is a covering for an airbag.
